(19) United States
(12) Patent Application Publication
(10) Pub. No.: US 2015/0130990 A1
(43) Pub. Date: May 14, 2015

(54) CAMERA MODULE

(71) Applicant: SAMSUNG ELECTRO-MECHANICS CO., LTD., Suwon-Si (KR)

(72) Inventors: Ho Yun CHO, Suwon-Si (KR); Hee Bum Lee, Suwon-Si (KR); Young Seok Yoon, Suwon-Si (KR)

(73) Assignee: SAMSUNG ELECTRO-MECHANICS CO., LTD., Suwon-Si (KR)

(21) Appl. No.: 14/244,695

(22) Filed: Apr. 3, 2014

(30) Foreign Application Priority Data
Nov. 12, 2013 (KR) 10-2013-0136992

(51) Int. Cl. H04N 5/225; G03B 13/36

(52) U.S. Cl. CPC H04N 5/2253; G03B 13/36
USPC 348/357

(57) ABSTRACT

There is provided a camera module, including: a housing including a lens barrel therein; an actuator including a driving coil wound around an outer surface of the lens barrel and a magnet disposed in the housing to face the driving coil; a substrate disposed on a lower portion of the housing and having an image sensor attached to one surface thereof; and an offset coil provided on the substrate, wherein the driving coil generates a magnetic field in a direction toward the offset coil and the offset coil generates a magnetic field in a direction toward the driving coil.

### CROSS-REFERENCE TO RELATED APPLICATIONS

This application claims the priority of Korean Patent Application No. 10-2013-0136992 filed on Nov. 12, 2013, in the Korean Intellectual Property Office, the disclosure of which is incorporated herein by reference.

### BACKGROUND

The present disclosure relates to a camera module.

Recently, mobile communications terminals such as cellular phones, personal digital assistants (PDA), portable personal computers (PC), and the like, have generally been implemented with the ability to perform the transmission of video data as well as the transmission of text and audio data.

In accordance with this trend, mobile communications terminals have come to be standardly equipped with camera modules in order to allow for the transmission of video data, video chatting, and the like.

Generally, camera modules include a lens barrel having a lens disposed therein, a housing receiving the lens barrel therein, and an image sensor converting an image of a subject into electrical signals.

In addition, a single focus type camera module for imaging an object with a fixed focus may be adopted in a camera module. However, recently, in accordance with ongoing technological development, camera modules including actuators to allow autofocusing to be adjusted have been widely adopted.

As one kind of such an actuator, a voice coil motor generating driving force through interaction between a magnet and a coil has been used.

Generally, such a voice coil motor type actuator has a structure in which a plurality of magnets are disposed in a lens barrel and the vicinage thereof, the lens barrel having coils wound therearound, such that it may generate driving force through electromagnetic interaction between the coil and the plurality of magnets and move the lens barrel along an optical axis thereof.

However, a magnetic field generated by the coil during a process of driving the actuator may affect an image sensor to thereby cause noise.

That is, in a case in which the magnetic field generated by the coil affects the image sensor, noise may be generated by induced electromotive force in accordance with Faraday's law inside a circuit including the image sensor, or an eddy current generated when the magnetic field contacts a conductor.

### SUMMARY

An aspect of the present disclosure may provide a camera module capable of suppressing a generation of noise due to an influence of a magnetic field by offsetting the magnetic field incident on an image sensor.

According to an aspect of the present disclosure, a camera module may include: a housing including a lens barrel therein; an actuator including a driving coil wound around an outer surface of the lens barrel and a magnet disposed in the housing to face the driving coil; a substrate disposed on a lower portion of the housing and having an image sensor attached to one surface thereof; and an offset coil provided on the substrate, wherein the driving coil generates a magnetic field in a direction toward the offset coil and the offset coil generates a magnetic field in a direction toward the driving coil.

The offset coil may be provided to enclose a periphery portion of the image sensor.

The offset coil may be provided as a patterned metal layer on one surface of the substrate.

The offset coil may be a wound coil embedded in the substrate.

The offset coil may be formed to have a quadrangular vortex shape.

The driving coil and the offset coil may have a common winding direction, and may have power applied thereto in such a manner that a current flows in opposing directions in the coils.

The driving coil and the offset coil may have opposite winding directions, and may have power applied thereto in such a manner that a current flows in the same direction in the coils.

The driving coil and the offset coil may generate the magnetic fields having the same degree of strength.

According to another aspect of the present disclosure, a camera module may include: a housing including a lens barrel therein; an actuator including a driving coil wound around an outer surface of the lens barrel and a magnet disposed in the housing to face the driving coil; a substrate disposed on a lower portion of the housing and having an image sensor attached to one surface thereof; and an offset coil provided in a pattern form on the substrate to enclose a periphery portion of the image sensor, wherein the offset coil generates a magnetic field in a direction opposite to a direction of a magnetic field generated by the driving coil.

The driving coil and the offset coil may have a common winding direction, and may have power applied thereto in such a manner that a current flows in opposing directions in the coils.

The driving coil and the offset coil may have opposite winding directions, and may have power applied thereto in such a manner that a current flows in the same direction in the coils.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an exploded perspective view of a camera module according to an exemplary embodiment of the present disclosure;

FIG. 2 is a schematic cross-sectional view of the camera module according to an exemplary embodiment of the present disclosure;

FIG. 3 is a conceptual view showing an arrangement relationship of a driving coil, an image sensor, an offset coil, and a substrate in the camera module according to an exemplary embodiment of the present disclosure; and

FIG. 4 is a conceptual view showing a form in which the driving coil and the offset coil generate magnetic fields in directions toward each other in the camera module according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

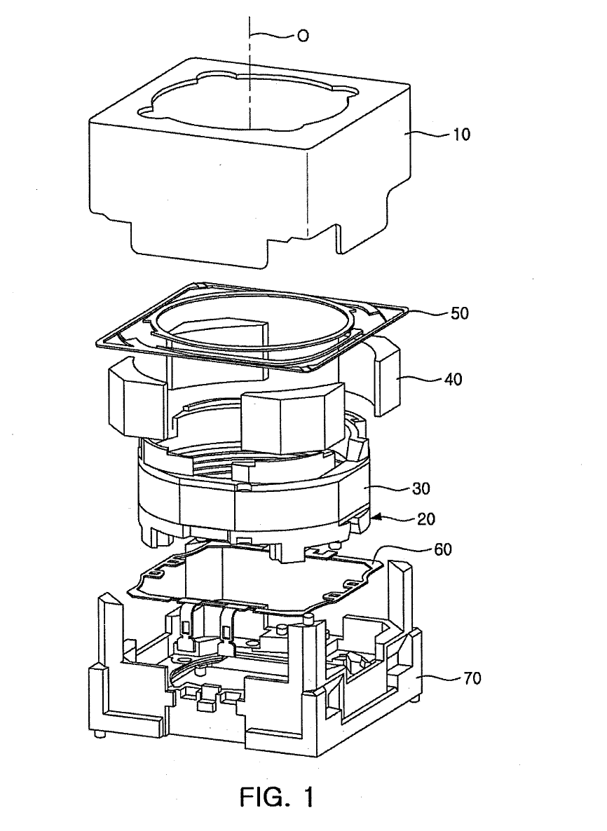

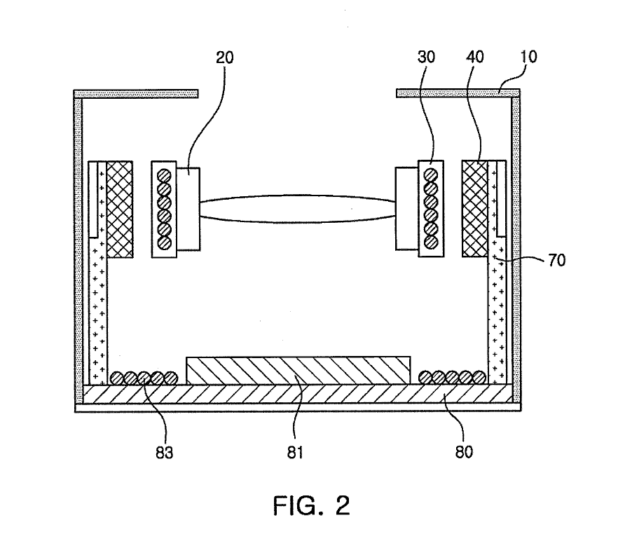

FIG. 1 is an exploded perspective view of a camera module according to an exemplary embodiment of the present disclosure and FIG. 2 is a schematic cross-sectional view of the camera module according to an exemplary embodiment of the present disclosure.

First, terms with respect to directions will be defined.

An optical axis direction refers to a vertical direction based on O in FIG. 1.

Referring to FIG. 1, a camera module according to an exemplary embodiment of the present disclosure may include a lens barrel 20, a housing 70, a case 10, an actuator, an image sensor 81, and a substrate 80.

The lens barrel 20 may have a hollow cylindrical shape so that a plurality of lenses for imaging a subject may be received therein, and the plurality of lenses may be provided in the lens barrel 20 along an optical axis 0.

The lens barrel 20 may be coupled to the housing 70. By way of example, the lens barrel 20 may be provided in the housing 70.

Here, the lens barrel 20 may move in the optical axis direction for autofocusing.

In order to move the lens barrel 20 in the optical axis direction, an actuator including a voice coil motor may be provided within the housing 70.

The actuator may include a driving coil 30 and a magnet 40, and the driving coil 30 may move the lens barrel 20 in the optical axis direction by attractive force and repulsive force between the driving coil 30 and the magnet 40 adjacent thereto.

Byway of example, the driving coil 30 maybe wound around an outer surface of the lens barrel 20 and the magnet 40 may be disposed in the housing 70 to face the driving coil 30.

Driving force may be generated by electromagnetic interaction between the magnet 40 and the driving coil 30 disposed to face each other and the lens barrel 20 may move in the optical axis direction by the driving force.

The lens barrel 20 may be moved by the operation as described above to perform an autofocusing or zooming function.

Here, the magnet 40 may be formed to have four independent polyhedral portions, but is not necessarily limited thereto. As long as the magnet 40 may have a shape capable of moving the lens barrel 20 in the optical axis direction by electrical interaction with the driving coil 30, a shape thereof is not limited.

Meanwhile, a first elastic member 50 and a second elastic member 60 may be provided in upper and lower portions of the lens barrel 20, respectively, to support the lens barrel 20.

The case 10 may be coupled to the housing 70 to enclose an outer surface of the housing 70 and serve to shield electromagnetic waves generated at the time of driving the camera module.

That is, when the camera module is driven, electromagnetic waves may be generated therein. In a case in which electromagnetic waves, as described above, are outwardly emitted, the electromagnetic waves may have an effect on other electronic components to cause communication interference or a malfunction.

Therefore, in order to prevent electromagnetic waves from being outwardly emitted, the case 10 may be coupled to the housing 70.

Here, the case 10 may be grounded to a ground pad (not shown) provided on the substrate 80 to thereby shield electromagnetic waves.

The case 10 may have a through-hole formed in an upper portion thereof so that external light may be incident through the lens barrel 20, and the external light incident through the through-hole may be received in the image sensor 81 through the lenses.

The image sensor 81, collecting light incident through the lens barrel 20 to generate an image signal, may be formed of a complementary metal oxide semiconductor (CMOS) sensor or a charge coupled device (CCD) sensor.

The image sensor 81 may be mounted on one surface of the substrate 80 by a wire bonding, an adhesive, or the like to be electrically connected to the substrate 80, and the substrate 80 may be disposed on a lower portion of the housing 70.

An image of a subject maybe collected in the image sensor 81 and be stored as data in a memory in a device, and the stored data may be displayed as an image by a display medium in the device.

Here, the lens barrel 20 and the image sensor 81 may have an infrared filter (not shown) disposed therebetween.

That is, the infrared filter (not shown) may be disposed below the lens barrel 20.

When light having passed through the lenses passes through the infrared filter (not shown) , an infrared light within the light may be cut off. Therefore, the introduction of infrared light into the image sensor 81 may be prevented.

The infrared filter (not shown) may be formed of a glass material and be manufactured by depositing several materials having different refractive indices on a surface thereof in order to filter light within the infrared region.

The infrared filter (not shown) may be bonded to an inner surface of the housing 70.

For example, the infrared filter (not shown) and the housing 70 may be bonded to each other through an ultraviolet (UV) adhesive (not shown).

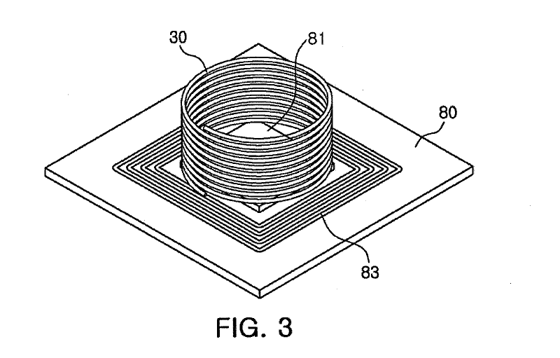

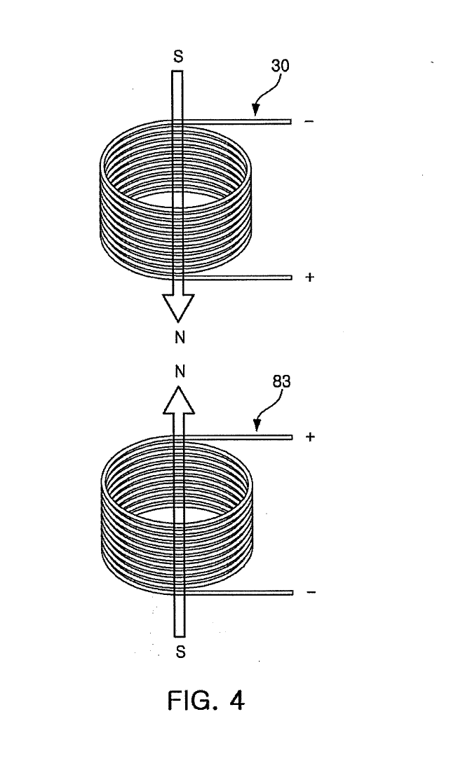

Meanwhile, the substrate 80 may be further provided with an offset coil 83. A description thereof will be provided below with reference to FIGS. 3 and 4.

FIG. 3 is a conceptual view showing an arrangement relationship of a driving coil, an image sensor, an offset coil, and a substrate in the camera module according to an exemplary embodiment of the present disclosure, and FIG. 4 is a conceptual view showing a form in which the driving coil and the offset coil generate magnetic fields in directions toward each other in the camera module according to an exemplary embodiment of the present disclosure.

Referring to FIGS. 3 and 4, the driving coil 80 may be wound around an outer surface of the lens barrel 20, and the substrate 80 disposed below the lens barrel 20 may be provided with the offset coil 83.

The substrate 80, an insulated substrate having rigidity, may be, for example, a printed circuit board (PCB), a ceramic substrate, a pre-molded substrate, a direct bonded copper (DBC) substrate, an insulated metal substrate (IMS), a flexible substrate, or the like, and may be formed of a single or a multilayer substrate.

However, the substrate according to an exemplary embodiment of the present disclosure is not limited thereto but a flexible PCB having a reduced thickness and a wiring pattern formed therein, such as a film, a thin printed circuit board, or the like may be used, if necessary.

Here, the image sensor 81 may be mounted on one surface of the substrate 80 and the offset coil 83 may be provided to enclose a periphery portion of the image sensor 81.

The offset coil 83 may be provided as a patterned metal layer on one surface of the substrate 80.

That is, the offset coil 83 may be formed on one surface of the substrate 80 by a patterning process.

In addition, the offset coil 83 may be formed to have a wiring pattern form on one surface of the substrate 80 and may be formed to include a plurality of layers.

However, the present disclosure is not limited thereto. The offset coil 83 may be formed by embedding a wound coil in the substrate 80.

The offset coil 83 may be formed to have a quadrangular vortex shape on one surface of the substrate 80 to enclose the periphery portion of the image sensor 81.

Although an exemplary embodiment of the present disclosure describes a case in which the offset coil 83 is generally formed to have a quadrangular vortex shape, by way of example, the offset coil 83 according to an exemplary embodiment of the present disclosure is not limited thereto but may be variously formed. For example, the offset coil 83 may have a circular vortex shape, a polygonal vortex shape, or the like.

Here, the offset coil 83 may generate a magnetic field in a direction opposite to a direction of a magnetic field, generated by the driving coil 30.

For example, referring to FIG. 4, the driving coil 30 may generate the magnetic field in a direction toward the offset coil 83 and the offset coil 83 may generate the magnetic field in a direction toward the driving coil 30.

Therefore, in the camera module according to an exemplary embodiment of the present disclosure, the driving coil 30 and the offset coil 83 may generate magnetic fields in opposing directions.

In addition, strength of the magnetic field generated by the driving coil 30 and strength of the magnetic field generated the offset coil 83 may be identical to each other. Therefore, the magnetic fields having the same degree of strength may be formed in opposing directions.

When the lens barrel 20 is moved in the optical axis direction by the driving of the actuator, the driving coil 30 may generate the magnetic field toward the image sensor 81.

Therefore, the image sensor 81 may be exposed to the magnetic field, such that noise may be generated.

That is, in a case in which the magnetic field, generated by the driving coil 30 affects the image sensor 81, the noise may be generated by induced electromotive force generated by Faraday's law inside a circuit including the image sensor 81, or an eddy current generated when the magnetic field contacts a conductor.

Therefore, the camera module according to an exemplary embodiment of the present disclosure includes the offset coil 83 to generate the magnetic field in the direction opposite to the direction of the magnetic field of the driving coil 30, such that the magnetic field incident on the image sensor 81 may be offset.

In other words, in the camera module according to an exemplary embodiment of the present disclosure, the driving coil 30 and the offset coil 83 may generate magnetic fields having the same degree of strength in opposing directions, such that the magnetic field incident on the image sensor 81 may be offset.

Since the magnetic field is offset as described above, the generation of the noise from the image sensor 81 due to the influence of the magnetic field may be suppressed.

Hereinafter, a method of generating magnetic fields by the driving coil 30 and the offset coil 83 in opposing directions will be described.

First, a case in which the driving coil 30 provided on the outer surface of the lens barrel 20 and the offset coil 83 enclosing the periphery portion of the image sensor 81 have a common winding direction will be described.

Since the driving coil 30 and the offset coil 83 have a common winding direction, the driving coil 30 and the offset coil 83 may generate magnetic fields in opposing directions by enabling a direction in which a current flows in the driving coil 30 and a direction in which a current flows in the offset coil 83 to be opposite to each other.

Next, a case in which the driving coil 30 provided on the outer surface of the lens barrel 20 and the offset coil 83 enclosing the periphery portion of the image sensor 81 have opposite winding directions will be described.

Since the winding directions of the driving coil 30 and the offset coil 83 are opposite to each other, the driving coil 30 and the offset coil 83 may generate magnetic fields in opposing directions by enabling the direction in which a current flows in the driving coil 30 and the direction in which a current flows in the offset coil 83 to be identical to each other.

As set forth above, in the camera module according to exemplary embodiments of the present disclosure, the occurrence of noise due to the influence of the magnetic field may be suppressed by offsetting the magnetic field incident on the image sensor.

While exemplary embodiments have been shown and described above, it will be apparent to those skilled in the art that modifications and variations could be made without departing from the spirit and scope of the present disclosure as defined by the appended claims.

What is claimed is:

1. A camera module, comprising:
a housing including a lens barrel therein;
an actuator including a driving coil wound around an outer surface of the lens barrel and a magnet disposed in the housing to face the driving coil;
a substrate disposed on a lower portion of the housing and having an image sensor attached to one surface thereof; and
an offset coil provided on the substrate,
wherein the driving coil generates a magnetic field in a direction toward the offset coil and the offset coil generates a magnetic field in a direction toward the driving coil.

2. The camera module of claim 1, wherein the offset coil is provided to enclose a periphery portion of the image sensor.

3. The camera module of claim 1, wherein the offset coil is provided as a patterned metal layer on one surface of the substrate.

4. The camera module of claim 1, wherein the offset coil is a wound coil embedded in the substrate.

5. The camera module of claim 1, wherein the offset coil is formed to have a quadrangular vortex shape.

6. The camera module of claim 1, wherein the driving coil and the offset coil have a common winding direction, and have power applied thereto in such a manner that a current flows in opposing directions in the coils.

7. The camera module of claim 1, wherein the driving coil and the offset coil have opposite winding directions, and have power applied thereto in such a manner that a current flows in the same direction in the coils.

8. The camera module of claim 1, wherein the driving coil and the offset coil generate the magnetic fields having the same degree of strength.

9. A camera module, comprising:
a housing including a lens barrel therein;
an actuator including a driving coil wound around an outer surface of the lens barrel and a magnet disposed in the housing to face the driving coil;
a substrate disposed on a lower portion of the housing and having an image sensor attached to one surface thereof; and
an offset coil provided in a pattern form on the substrate to enclose a periphery portion of the image sensor,
wherein the offset coil generates a magnetic field in a direction opposite to a direction of a magnetic field generated by the driving coil.

10. The camera module of claim 9, wherein the driving coil and the offset coil have a common winding direction, and have power applied thereto in such a manner that a current flows in opposing directions in the coils.

11. The camera module of claim 9, wherein the driving coil and the offset coil have opposite winding directions, and have power applied thereto in such a manner that a current flows in the same direction in the coils.
